(19) United States
(12) Patent Application Publication
(10) Pub. No.: US 2026/0199807 A1
(43) Pub. Date: Jul. 16, 2026

(54) SUPERCRITICAL AND SUBCRITICAL FLUID DEVICE, SOLVENT EXTRACTION AND SEPARATION METHOD, AND METHOD FOR PRODUCING PRODUCT

(71) Applicant: TOHOKU UNIVERSITY, Sendai-shi, Miyagi (JP)

(72) Inventors: Masaki OTA, Sendai-shi (JP); Hiroshi INOMATA, Sendai-shi (JP)

(21) Appl. No.: 19/137,484

(22) PCT Filed: Dec. 7, 2023
(86) PCT No.: PCT/JP2023/043813

§ 371 Date: Jun. 10, 2025

(30) Foreign Application Priority Data
Dec. 13, 2022 (JP) 2022-198740

(51) Int. Cl. B01D 11/04

(52) U.S. Cl. CPC B01D 11/0407; B01D 11/0484

(57) ABSTRACT

Disclosed is a supercritical and subcritical fluid device, a solvent extraction and separation method using the supercritical and subcritical fluid device, and a method for producing a product. The supercritical and subcritical fluid device includes a extraction and separation column, a first liquid feeding part, a second liquid feeding part, a first back pressure adjustment mechanism that sets an inside of the extraction and separation column into a first pressurized state in which a fluid in a supercritical state is maintained in a supercritical fluid state, a second back pressure adjustment mechanism that sets the inside of the extraction and separation column into a second pressurized state in which the fluid in a supercritical state is maintained in a supercritical fluid state, and a control unit that controls the first back pressure adjustment mechanism and the second back pressure adjustment mechanism. The control unit controls the first back pressure adjustment mechanism and the second back pressure adjustment mechanism such that the second pressurized state is reduced by a predetermined pressure difference with respect to the first pressurized state.

### CROSS-REFERENCE TO RELATED APPLICATIONS

This application is the U.S. National Stage entry of International Application No. PCT/JP2023/043813, filed on Dec. 7, 2023, which, in turn, claims priority to JP Patent Application No. 2022-198740, filed on Dec. 13, 2022, both of which are hereby incorporated herein by reference in their entireties for all purposes.

### TECHNICAL FIELD

The present invention relates to a supercritical and subcritical fluid device, a solvent extraction and separation method using the supercritical and subcritical fluid device, and a method for producing a product.

### BACKGROUND ART

In recent years, the use of naturally-derived functional components has attracted attention due to increased health consciousness and increased interest in safety of people. These components have attracted attention for use for the purpose of health maintenance and promotion from the food field to the medical field, and in particular, have attracted more attention for use in food related fields such as supplements, health foods, and beverages. In addition, also in the fields of cosmetics, non-prescription and prescription drugs, and the like, naturally-derived functional components have attracted attention as key materials for improving the added value of products.

In the producing process of pharmaceutical and food materials related to these naturally-derived functional components, a large amount of an organic solvent having a high environmental load may be used for the purpose of dissolving a target substance.

On the other hand, since some organic solvents affect the human body, the Ministry of Health, Labour and Welfare (Japan) sets a guideline for the residual solvent in the production of drugs, which is generally known (see Internet URL; HTTPS://WWW.pmda.go.jp/files/000156502.pdf).

At present, it is not clear whether a problem such as a side effect caused by a residual solvent occurs in a patient or a user who takes drugs, supplements, foods, or the like produced under the regulation as described above orally or transdermally for a long time. There are similar regulations in the producing process of food additives and the like, but as long as an organic solvent is used to dissolve a target substance, problems related to the residual solvent as described above cannot be avoided.

In the background described above, the inventors of the invention have conducted intensive studies on solvent extraction and separation techniques that are friendly to humans and the environment and use only substances present in large quantities in nature, such as water, ethanol, and carbon dioxide (CO₂), as techniques for producing reliable and safe pharmaceutical and food materials. The inventors have proposed a method in which, based on a fact in NPL 1 that, among the above substances, water functions as a highly polar solvent, ethanol functions as an amphipathic solvent, and CO₂ functions as a low polar solvent comparable to n-hexane under high pressure, these properties are highly utilized under high pressure. NPL 1 discloses, as a counterflow supercritical fluid device that extracts and separates a solvent, a device having a configuration in which a gas (gas phase) is recovered from an upper portion of an extraction and separation column and a separated substance (liquid phase: including a target substance) is recovered from a lower portion (bottom portion) thereof, and an interlocking automatic back pressure valve is provided at each of two discharge ports for the gas phase and the liquid phase in the extraction and separation column. According to the supercritical fluid device disclosed in NPL 1, since a time interval between an open state and a closed state of each back pressure valve can be controlled by the above configuration, it is possible to efficiently and reliably perform extraction and separation of the solvent without causing a failure in continuous liquid feeding of both gas and liquid phases separated once.

In addition, in NPL 2, it is proposed to provide a lower limit for the extraction time from an extraction container for the purpose of preventing damage to the container due to rapid depressurization of the extraction container (column) in a co-current flow type fluid device.

In addition, PTL 1 proposes a counterflow contact device in which a raw material is fed from a fermentation alcohol supply line and a solubilizer is fed from a solubilizer supply line, and the raw material and the solubilizer are brought into counterflow contact with each other using the counterflow contact device when concentrating alcohol using supercritical. According to the counterflow contact device disclosed in PTL 1, alcohol is taken out from an upper take-out line of a light liquid such as alcohol and water is taken out from a lower take-out line of a heavy liquid such as water, and a pressure reducing valve provided in the upper line is opened to reduce the pressure, so that alcohol or the like can be taken out into an impurity separation tank and phase-separated.

PTL 2 proposes a system that recovers uranium or the like from a metal-containing substance. In the system disclosed in PTL 2, a metal-containing substance containing a supercritical fluid solvent or the like is disposed in a first station and a second station, and an extraction material is introduced into the second station and then introduced into the first station 18 to extract a metal. Thereafter, the extract is moved to a separation column, and a gas component is moved to a separator to reduce the pressure, and then a gas and a complexing agent are separated.

### CITATION LIST

### Patent Literature

PTL 1: JPS62-25985A
PTL 2: JP2008-533442A

### Non Patent Literature

NPL 1: Y. Hoshino et al., “Fractionation of hops-extract-ethanol solutions using dense CO2 with a counter-current extraction column”, The Journal of Supercritical Fluids 136(2018), 37-43
NPL 2: E. A. Richter et al., “Thermodynamic properties of CO2 during controlled decompression of supercritical extraction vessels”, J. of Supercritical Fluids 98(2015), 102-110

### SUMMARY OF INVENTION

### Technical Problem

As described above, when a sample or the like containing a target component necessary in a producing process using a supercritical fluid solvent or the like is subjected to gas phase separation using a fluid device including a counterflow column to obtain a target substance on the liquid phase side, it generally tends to take time for pretreatment of the sample. Depending on the pretreatment method, an organic solvent may remain, or some components may be reduced or denatured. For example, in a method of extracting and separating a functional component from a natural product, a pretreatment process of (1) drying, (2) pulverizing, and (3) extracting, with an organic solvent, a solid natural product sample is generally required. For this reason, the inventors have tried whether a sample obtained by directly converting a natural product raw material into a hydrothermal paste can be subjected to a faster extraction treatment under a condition of not using an organic solvent without taking time for pretreatment and without losing a target component. However, the sample obtained by the hydrothermal paste method contains a slurry, and when such a sample is used in a producing process in the related art in which a supercritical fluid is employed, the following problems occur.

At an outlet side of a back pressure valve in the producing process using a supercritical fluid, since the supercritical fluid adiabatically expands, freezing due to a decrease in temperature is likely to occur. Therefore, when the slurry is fed in a fluid device, the slurry containing solid content is frozen on the outlet side of the back pressure valve, and thus clogging may occur in this portion. In this case, for example, it is conceivable to install a heater on the outlet side of the back pressure valve for heating. However, in a discharge system using the interlocking back pressure valve disclosed in NPL 1, since the solenoid back pressure valve having a high opening and closing speed is used in addition to a thin tube of 1/16 inches, there is a problem that the discharge system is easily clogged.

As described above, when the fluid device in the related art is used for the purpose of taking out a slurry-like separated substance, it may be necessary to stop the process due to the occurrence of clogging of the back pressure valve on the liquid phase side and to frequently perform maintenance. For this reason, there is a problem that a decrease in productivity is caused and time and cost required for maintenance are increased.

The invention has been made in view of the above problems, and an object of the invention is to provide a supercritical and subcritical fluid device, a solvent extraction and separation method using the supercritical and subcritical fluid device, and a method for producing a product, in which a back pressure valve, a pipe, or the like is not clogged even when taking out a slurry-like separated substance from a liquid phase side, and productivity and maintainability are excellent.

### Solution to Problem

In order to solve the above problems, the inventors have conducted further intensive studies. As a result, it was found that by optimizing the configuration and the opening and closing conditions of the back pressure valve and adopting a configuration in which a pressure difference is generated between the gas phase side and the liquid phase side in the extraction and separation column, it is possible to restrict the occurrence of rapid adiabatic expansion on the outlet side of the back pressure valve and to prevent the occurrence of clogging due to freezing of the slurry-like separated substance. Further, the inventors have found that, by generating a pressure difference between the gas phase side and the liquid phase side, it becomes easy to take out the separated s substance (target substance) containing a slurry from a discharge port on the liquid phase side disposed in a lower portion of the extraction and separation column, and have completed the invention.

That is, the invention has the following aspects.

The invention provides a supercritical and subcritical fluid device, a solvent extraction and separation method using the supercritical and subcritical fluid device, and a method for producing a product containing a target substance obtained using the supercritical and subcritical fluid device as a functional component. The supercritical and subcritical fluid device includes a extraction and separation column, a first liquid feeding part connected to a lower portion of the extraction and separation column via a first flow path and configured to supply a mobile phase serving as a supercritical fluid, a second liquid feeding part connected to an upper portion of the extraction and separation column via a second flow path and configured to supply a separation target, a first back pressure adjustment mechanism connected to the lower portion of the extraction and separation column via a third flow path and configured to set an inside of the extraction and separation column to a first pressurized state in which the mobile phase is maintained in a supercritical fluid state, a second back pressure adjustment mechanism connected to the upper portion of the extraction and separation column via a fourth flow path and configured to set the inside of the extraction and separation column to a second pressurized state in which the mobile phase is maintained in a supercritical fluid state, and a control unit configured to control the first back pressure adjustment mechanism and the second back pressure adjustment mechanism. The control unit controls the first back pressure adjustment mechanism and the second back pressure adjustment mechanism such that the second pressurized state is reduced by a predetermined pressure difference with respect to the first pressurized state.

That is, the invention has the following aspects.
[1] A supercritical and subcritical fluid device including: a extraction and separation column; a first liquid feeding part connected to a lower portion of the extraction and separation column via a first flow path and configured to Supply a mobile phase serving as a supercritical fluid; a second liquid feeding part connected to an upper portion of the extraction and separation column via a second flow path and configured to supply a separation target; a first back pressure adjustment mechanism connected to the lower portion of the extraction and separation column via a third flow path and configured to set an inside of the extraction and separation column to a first pressurized state in which the mobile phase is maintained in a supercritical fluid state; a second back pressure adjustment mechanism connected to the upper portion of the extraction and separation column via a fourth flow path and configured to set the inside of the extraction and separation column to a second pressurized state in which the mobile phase is maintained in a supercritical fluid state; and a control unit configured to control the first back pressure adjustment mechanism and the second back pressure adjustment mechanism, in which the control unit controls the first back pressure adjustment mechanism and the second back pressure adjustment mechanism such that the second pressurized state is reduced by a predetermined pressure difference with respect to the first pressurized state.
[2] The supercritical and subcritical fluid device according to [1], in which
   in the third flow path, a cross-sectional area of a flow path downstream of the first back pressure adjustment mechanism is larger than a cross-sectional area of a flow path connected to the first back pressure adjustment mechanism on a extraction and separation column side.
[3] The supercritical and subcritical fluid device according to [1] or [2], in which
   the control unit controls the first back pressure adjustment mechanism and the second back pressure adjustment mechanism such that the pressure in the second pressurized state is lower by a range of 0.05 MPa to 0.15 MPa than the pressure in the first pressurized state.
[4] The supercritical and subcritical fluid device according to any one of [1] to [3], in which
   the control unit
   (i) opens the second back pressure adjustment mechanism for a first predetermined time in a state in which the first back pressure adjustment mechanism is closed, and extracts a first predetermined amount to reduce the pressure in the second pressurized state with respect to the pressure in the first pressurized state,
   (ii) opens the first back pressure adjustment mechanism for a second predetermined time in a state in which the second back pressure adjustment mechanism is closed, and extracts a second predetermined amount, and
   (iii) repeats the operations (i) and (ii) to control the second pressurized state to have a pressure lower by the predetermined pressure difference with respect to the first pressurized state.
[5] The supercritical and subcritical fluid device according to any one of [1] to [4], in which
   the separation target contains a slurry-like target substance.
[6] The supercritical and subcritical fluid device according to any one of [1] to [5], in which
   the control unit further performs control to collect an extract containing the slurry-like target substance contained in the separation target by closing the second back pressure adjustment mechanism and opening the first back pressure adjustment mechanism.
[7] A solvent extraction and separation method including:
   separating and recovering a target substance from a separation target by bringing a mobile phase serving as a supercritical fluid into counterflow contact with the separation target in the extraction and separation column and extracting and separating a solvent from the separation target using the supercritical and subcritical fluid device according to any one of [1] to [6].
[8] A method for producing a product, the method including:
   concentrating and separating a target substance from a separation target using the supercritical and subcritical fluid device according to any one of [1] to [6], and producing a product containing the concentrated and separated target substance as a functional component.

### Advantageous Effects of Invention

According to the supercritical and subcritical fluid device of the invention, as described above, the control unit controls the first back pressure adjustment mechanism and the second back pressure adjustment mechanism such that the pressure in the second pressurized state is reduced by the predetermined pressure difference with respect to the pressure in the first pressurized state. Accordingly, since a pressure difference occurs between a gas phase side and a liquid phase side in the extraction and separation column, it is possible to restrict the occurrence of rapid adiabatic expansion on an outlet side of the first back pressure adjustment mechanism and to prevent the occurrence of clogging due to freezing of the slurry-like separated substance. In addition, since a pressure difference occurs between the gas phase side and the liquid phase side, it is easy to take out the slurry-like separated substance from the liquid phase side disposed on the lower portion of the extraction and separation column.

Therefore, it is possible to provide a supercritical and subcritical fluid device excellent in productivity and maintainability.

According to the solvent extraction and separation method of the invention, a method of separating and recovering the target substance from the separation target by bringing the mobile phase serving as a supercritical fluid into counterflow contact with the separation target in the extraction and separation column and extracting and separating the solvent from the separation target using the supercritical and subcritical fluid device according to the invention having the above-described configuration is adopted. Accordingly, similarly to the above, it is possible to prevent the slurry-like separated substance from freezing and causing clogging on the outlet side of the first back pressure adjustment mechanism, and it is easy to take out the slurry-like separated substance from the liquid phase side.

Therefore, it is possible to continuously separate and recover the target substance from the separation target with high productivity.

According to the method for producing a product according to the invention, similarly to the above, since the method for producing a product according to the invention is a method for producing a product containing the target substance obtained by using the supercritical and subcritical fluid device according to the invention having the above-described configuration as a functional component, it is possible to prevent the slurry-like separated substance from freezing and causing clogging on the outlet side of the first back pressure adjustment mechanism, and it is easy to take out the slurry-like separated substance from the liquid phase side.

### BRIEF DESCRIPTION OF DRAWINGS

FIG. 1 is a diagram schematically illustrating a supercritical and subcritical fluid device, a solvent extraction and separation method, and a method for producing a product according to an embodiment of the invention, and is a system diagram illustrating an example of a supercritical fluid device.

### DESCRIPTION OF EMBODIMENTS

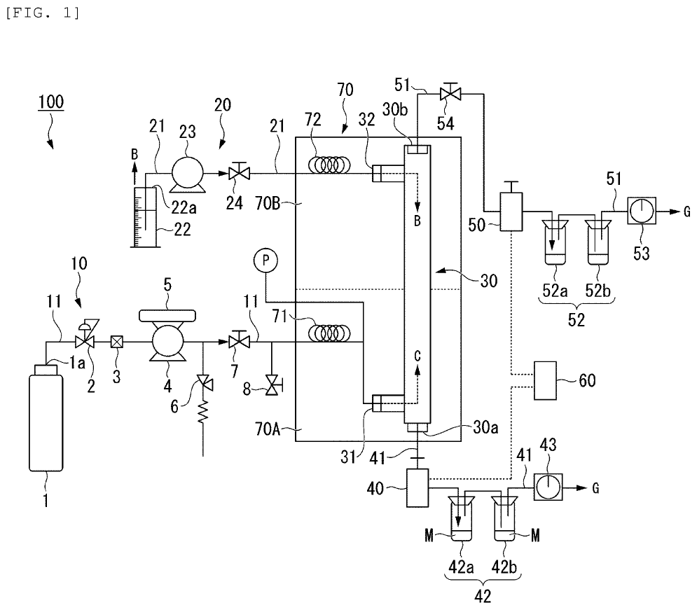

Hereinafter, an embodiment of a supercritical and subcritical fluid device, a solvent extraction and separation method, and a method for producing a product according to the invention will be described with reference to FIG. 1.

In the drawing used in the following description, in order to facilitate understanding of features thereof, characteristic portions may be enlarged for convenience, and dimensional ratios and the like may be different from actual ones. A material, a dimension, and the like exemplified in the following description are merely examples, and the invention is not limited thereto, and can be appropriately modified and implemented without departing from the gist of the invention.

### <Supercritical Fluid Device>

Hereinafter, an overall configuration of a supercritical and subcritical fluid device according to an embodiment will be described in detail with reference to FIG. 1.

FIG. 1 is a system diagram schematically illustrating an overall configuration of a supercritical and subcritical fluid device 100 according to the embodiment.

The term “supercritical” in the invention is used by its common meaning in the present technical field. That is, it means a state in which a property as a liquid (dissolving power) and a property as a gas (diffusing power) are provided at a predetermined temperature and a predetermined high pressure. On the other hand, the term “subcritical” in the invention refers to a state at a temperature and pressure slightly lower than a critical point in the supercritical state. In the invention, concentration of a target object is performed using a fluid in a normal supercritical state, but as will be described in detail later, since a pressure of the device is partially reduced, a subcritical state is partially included in the processing process. Therefore, strictly speaking, the present invention is a supercritical and subcritical fluid device. Therefore, in the following description, the “supercritical and subcritical fluid device” is abbreviated as a “supercritical fluid device”, and the supercritical fluid device includes a range as a supercritical fluid device including a subcritical state under a reduced pressure in the invention.

As illustrated in FIG. 1, the supercritical fluid device 100 according to the embodiment includes a extraction and separation column 30, a first liquid feeding part 10, a second liquid feeding part 20, a first back pressure adjustment mechanism 40, a second back pressure adjustment mechanism 50, and a control unit 60 that controls the supercritical fluid device 100.

As will be described in detail later, the supercritical fluid device 100 according to the embodiment controls the first back pressure adjustment mechanism 40 and the second back pressure adjustment mechanism 50 by the control unit 60 such that a second pressurized state of the extraction and separation column 30 adjusted by the second back pressure adjustment mechanism 50 is reduced by a predetermined pressure difference with respect to a first pressurized state of the extraction and separation column 30 adjusted by the first back pressure adjustment mechanism 40. More specifically, in the supercritical fluid device 100, a lower portion side (a lower end 30a side in FIG. 1) of the extraction and separation column 30 is in the first pressurized state described above, and an upper portion side (an upper end 30b side in the same drawing) is in the second pressurized state.

The first liquid feeding part 10 is connected to a lower introduction port 31 of the extraction and separation column 30 via a first flow path 11 and supplies a mobile phase serving as a supercritical fluid, and in an example described in the embodiment, supplies a fluid C in a supercritical state to the lower portion of the extraction and separation column 30. The first liquid feeding part 10 in the illustrated example includes a supercritical fluid source storage tank 1, a pressure reducing valve 2, a filter 3, a liquid feeding pressure pump 4, a cooler 5, a safety valve 6, a flow rate control valve 7, and a vent valve 8.

The supercritical fluid source storage tank 1 stores therein a fluid source to be a supercritical fluid, and an outlet la on an upper end side is connected to the first flow path 11, so that the fluid source is supplied toward the extraction and separation column 30 via the first flow path 11. The supercritical fluid source storage tank 1 is not particularly limited, and a metal tank generally used in this field can be adopted without any limitation. In the embodiment, although an example in which carbon dioxide is used as a gas or a liquid to be a supercritical fluid has been described, water and organic carbon such as ethanol or glycerin can be used in addition to carbon dioxide.

The pressure reducing valve 2 is provided in the vicinity of the outlet la of the supercritical fluid source storage tank 1 in the path of the first flow path 11, and controls the fluid source led out from the supercritical fluid source storage tank 1 to have a constant pressure. The pressure reducing valve 2 is also not particularly limited, and for example, a pressure reducing valve having a general configuration used by being connected to a high pressure tank can be adopted without any limitation.

The filter 3 is provided downstream of the pressure reducing valve 2 in a flow direction of the fluid source in the path of the first flow path 11, and removes impurity components contained in the fluid source. The filter 3 is also not particularly limited, and a filter having a general configuration used for fluid purification treatment can be adopted.

As the liquid feeding pressure pump 4, for example, an HPLC pump (a pump for high performance liquid chromatography) is used. The liquid feeding pressure pump 4 is provided downstream of the filter 3 in a flow direction of the fluid C in the supercritical state in the path of the first flow path 11, and pressurizes and feeds the fluid source accommodated in the supercritical fluid source storage tank 1 via the first flow path 11. The liquid feeding pressure pump 4 is not limited to the HPLC pump, and a general plunger pump or the like used for pressure-feeding a fluid can be adopted.

The cooler 5 is used for cooling when the fluid source flowing through the first flow path 11 is adiabatically compressed, and is provided together with the liquid feeding pressure pump 4 in the illustrated example. The fluid C in a supercritical state is obtained by pressure-feeding the fluid source liquefied by the liquid feeding pressure pump 4. As such a cooler, for example, a general cooler using water, refrigerant, or the like can be adopted without any limitation.

The safety valve 6 can be urgently opened, for example, when some failures occur in the flow of the fluid C in the supercritical state in the path of the first flow path 11. The safety valve 6 is also not particularly limited, and a valve generally used in this field can be adopted.

The flow rate control valve 7 appropriately adjusts the supply amount of the fluid C in the supercritical state to the extraction and separation column 30. The flow rate control valve 7 is also not particularly limited, and a general valve used for flow rate control of a fluid can be adopted.

The vent valve 8 is provided to discharge air and an excess liquid, for example, when performing maintenance of the supercritical fluid device 100. The vent valve 8 is also not particularly limited, and a valve generally used in this field can be adopted without any limitation.

By the first liquid feeding part 10 having the above configuration, the fluid C in a supercritical state is supplied from the supercritical fluid source storage tank 1 into the extraction and separation column 30 from the lower introduction port 31 of the extraction and separation column 30, which will be described in detail later, via the first flow path 11 by the liquid feeding pressure pump 4 provided with the cooler 5.

The second liquid feeding part 20 is connected to an upper portion of the extraction and separation column 30 via a second flow path 21 and supplies a separation target. In one example described in the embodiment, a feed solution B containing a raw material (a sample containing a slurry in the embodiment) and a modifier ((co-solvent or entrainer), ethanol or an aqueous ethanol solution in the embodiment) is supplied to the upper portion of the extraction and separation column 30 as the separation target. The second liquid feeding part 20 in the illustrated example includes a separation target solution storage tank 22, a liquid feeding pressure pump 23, and a flow rate control valve 24.

The separation target solution storage tank 22 stores therein a raw material that is a separation target containing a target substance M and the feed solution B containing a modifier, and supplies the feed solution B toward the extraction and separation column 30 through the second flow path 21 by inserting one end of the second flow path 21 from an opening 22a on an upper end side. The separation target solution storage tank 22 is not particularly limited, and a metal tank, a glass container, or the like generally used in this field can be adopted without any limitation.

In the embodiment, since the feed solution B ma y contain a slurry, the separation target solution storage tank 22 may be configured to store therein the feed solution B containing the slurry.

The liquid feeding pressure pump 23 is disposed on the outlet side of the separation target solution storage tank 22 in the path of the second flow path 21, and feeds the feed solution B containing the raw material and the modifier stored in the separation target solution storage tank 22 via the second flow path 21. The liquid feeding pressure pump 23 is also not particularly limited, and a pump generally used for pressure-feeding a fluid can be adopted without any limitation.

The flow rate control valve 24 appropriately adjusts the supply amount of the feed solution B to the extraction and separation column 30. The flow rate control valve 24 is also not particularly limited, and a general valve used for flow rate control of a fluid can be adopted similarly to the flow rate control valve 7 described above.

In the extraction and separation column 30, the fluid C in a supercritical state, which is a mobile phase to be a supercritical fluid, is introduced from the lower introduction port 31, and the feed solution B, which is a separation target containing the target substance M, is introduced from the upper introduction port 32. Accordingly, the extraction and separation column 30 constitutes a so-called counterflow column inside which the fluid C in a supercritical state and the feed solution B come into contact with each other in a counterflow direction.

In the illustrated example, the extraction and separation column 30 is disposed inside an oven 70, the lower portion side (the lower end 30a side) is disposed inside a first oven 70A, and the upper portion side (the upper end 30b side) is disposed inside a second oven 70B.

As the extraction and separation column 30, a column in which a filler generally used for the purpose of supercritical extraction is accommodated is used. Examples of the filler include, but are not limited to, fillers such as Dickson packing. In the extraction and separation column 30, for example, the fluid C in a supercritical state and the feed solution B are brought into counterflow contact with each other by the filler described above, the feed solution B containing a raw material containing a raw material component, ethanol and water, so that each component that is the target substance M contained in the raw material is distributed between a gas phase and a liquid phase, and thus the components are concentrated and extracted from the lower end 30a and the upper end 30b.

The extraction and separation column 30 leads out a liquid phase extract from the lower end 30a side shown in FIG. 1 toward the first back pressure adjustment mechanism 40 described later, and leads out a gas phase extract from the upper end 30b side toward the second back pressure adjustment mechanism 50 described later.

As described above, the oven 70 has the first oven 70A on the lower portion side and the second oven 70B on the upper portion side. The first oven 70A and the second oven 70B are each configured to be able to heat an internal space, in which the extraction and separation column 30 is accommodated, by a heater or the like (not illustrated).

A pre-ribbon heater 71 that is attached to the first flow path 11 and pre-heats the fluid C in a supercritical state flowing through the first flow path 11 is provided inside the first oven 70A.

Further, a pre-ribbon heater 72 that is attached to the second flow path 21 and pre-heats the feed solution B flowing through the second flow path 21 is provided inside the second oven 70B.

Further, inside the first oven 70A, a pressure sensor P for detecting a pressure upstream of the extraction and separation column 30 is provided downstream of the pre-ribbon heater 71, which is disposed in the path of the first flow path 11, in the flow direction of the fluid C in a supercritical state.

The fluid C in a supercritical state flowing through the first flow path 11 is preheated to a predetermined temperature by the pre-ribbon heater 71 disposed inside the first oven 70A, and is supplied from the lower introduction port 31 into the extraction and separation column 30 while being heated as the supercritical fluid by the first oven 70A.

In the embodiment, for example, the feed solution B containing a raw material containing the target substance M derived from a natural product, ethanol, and water is supplied from the upper portion of the extraction and separation column 30 from the separation target solution storage tank 22 by the liquid feeding pressure pump 23. The feed solution B is pre-heated to a predetermined temperature by the pre-ribbon heater 72, and is supplied into the extraction and separation column 30 from the upper introduction port 32 while being heated by the second oven 70B.

The first back pressure adjustment mechanism 40 is a back pressure valve that is connected to the lower end (lower portion) 30a of the extraction and separation column 30 via a third flow path 41 and adjusts the inside of the extraction and separation column 30 to a first pressurized state in which the mobile phase is maintained in a supercritical fluid state. As the first back pressure adjustment mechanism 40, a spring type mechanical valve is preferable as the back pressure valve capable of finely changing the opening as necessary, and a generally used electromagnetic valve or the like can be adopted as long as its opening can be adjusted.

In addition, upstream of and downstream of the first back pressure adjustment mechanism 40, a diameter of a flow path pipe of the third flow path 41 may be increased (a cross-sectional area thereof may be increased).

For example, upstream of the first back pressure adjustment mechanism 40, a pipe having a size of 1/16 inch (about 1.6 mm) is generally used, but in the case of a sample containing a slurry, when a pipe having the same size is used as a pipe downstream of the first back pressure adjustment mechanism 40, the pipe is often clogged. Therefore, when a pipe having a larger inner diameter than the pipe upstream of the first back pressure adjustment mechanism 40, for example, a pipe having a size of ¼ inch (about 6.3 mm), which is four times the size of the pipe upstream of the first back pressure adjustment mechanism 40, is used as the pipe downstream of the first back pressure adjustment mechanism 40, clogging is unlikely to occur even when a sample containing a slurry is used. A cross-sectional area of the pipe downstream of the first back pressure adjustment mechanism 40 may be 4 times to 36 times, preferably 9 times to 25 times, more preferably 14 times to 18 times, and most preferably 16 times the cross-sectional area of the pipe upstream of the first back pressure adjustment mechanism 40. Here, the cross-sectional area of the pipe may be a cross-sectional area of a cross section perpendicular to a flow direction of the pipe.

Since adiabatic expansion is very likely to occur upstream of and downstream of the first back pressure adjustment mechanism 40, it is possible to prevent the pipe from being clogged by changing the inner diameter of the pipe at positions upstream of and downstream of the first back pressure adjustment mechanism 40 where the adiabatic expansion occurs.

The first back pressure adjustment mechanism 40 may be provided with a heater for preventing freezing.

A first separation tank 42 is disposed downstream of the first back pressure adjustment mechanism 40 in a flow direction of the liquid phase extract led out from the lower end 30a of the extraction and separation column 30. The first separation tank 42 in the example illustrated in FIG. 1 is implemented as a multistage tank including a front-stage tank 42a and a rear-stage tank 42b.

The first separation tank 42 separates the liquid phase extract, which is led out from the lower end 30a of the extraction and separation column 30 and depressurized by the first back pressure adjustment mechanism 40, into, for example, a slurry containing a concentrate of the target substance M and another slurry, and separates and recovers the concentrate of the target substance M.

At this time, a separated fluid (carbon dioxide gas) G can be recovered from a wet gas flowmeter 43 disposed at the rear stage and reused.

The second back pressure adjustment mechanism 50 is a back pressure valve that is connected to the upper end (upper portion) 30b of the extraction and separation column 30 via a fourth flow path 51 and adjusts the inside of the extraction and separation column 30 to a second pressurized state in which the mobile phase is maintained in a supercritical fluid state. In the illustrated example, the second back pressure adjustment mechanism 50 is connected to the upper end 30b of the extraction and separation column 30 via an outlet valve 54 provided in the fourth flow path 51. As the second back pressure adjustment mechanism 50, similarly to the first back pressure adjustment mechanism 40, a general electromagnetic valve or the like capable of finely changing its opening can be adopted.

The second back pressure adjustment mechanism 50 may be provided with a heater for preventing freezing.

Although there is no possibility of clogging since the second back pressure adjustment mechanism 50 contains almost no slurry, a diameter of a pipe of the fourth flow path 51 may be configured to be large similarly to the pipes upstream of and downstream of the first back pressure adjustment mechanism 40.

A second separation tank 52 is disposed downstream of the second back pressure adjustment mechanism 50 in a flow direction of the gas phase extract led out from the upper end 30b of the extraction and separation column 30. Similarly to the first separation tank 42, the second separation tank 52 in the example illustrated in FIG. 1 is also implemented as a multistage tank including a front-stage tank 52a and a rear-stage tank 52b.

The second separation tank 52 separates the gas phase extract, which is led out from the upper end 30b of the extraction and separation column 30 and depressurized by the second back pressure adjustment mechanism 50, into, for example, an aqueous ethanol solution that was a modifier and the fluid (carbon dioxide gas) G. At this time, the separated fluid (carbon dioxide gas) G can also be recovered from a dry gas flowmeter 53 in the rear stage and reused.

The wet gas flowmeter 43 is provided on an outlet side of the first separation tank 42, that is, on a downstream side in the flow direction of the liquid phase extract. The wet gas flowmeter 43 can detect a flow rate of the fluid (carbon dioxide gas) G separated in the first separation tank 42 in real time, and can monitor an operation condition of the supercritical fluid device 100 in real time.

The dry gas flowmeter 53 is provided on an outlet side of the second separation tank 52, that is, on a downstream side in the flow direction of the gas phase extract. The dry gas flowmeter 53 can detect a flow rate of the fluid (carbon dioxide gas) G separated by the second separation tank 52 in real time, and can similarly monitor the operation condition of the supercritical fluid device 100 in real time.

In FIG. 1, the control unit 60 controls the entire supercritical fluid device 100 such as the first back pressure adjustment mechanism 40 and the second back pressure adjustment mechanism 50, and in the embodiment, controls the first back pressure adjustment mechanism 40 and the second back pressure adjustment mechanism 50 in an interlocking manner.

The control unit 60 provided in the supercritical fluid device 100 according to the embodiment controls the first back pressure adjustment mechanism 40 and the second back pressure adjustment mechanism 50 such that the second pressurized state held by the second back pressure adjustment mechanism 50 in the extraction and separation column 30 is reduced by a predetermined pressure difference with respect to the first pressurized state held by the first back pressure adjustment mechanism 40.

The control unit 60 appropriately controls the opening of the first back pressure adjustment mechanism 40 and the second back pressure adjustment mechanism 50 based on detection values of the wet gas flowmeter 43 and the dry gas flowmeter 53 provided downstream of the extraction and separation column 30 in the flow direction of the respective fluids in addition to a detection value (pressure) of the pressure sensor P disposed upstream of the extraction and separation column 30.

Since the supercritical fluid device 100 according to the embodiment includes the control unit 60 that controls the first back pressure adjustment mechanism 40 and the second back pressure adjustment mechanism 50, it is possible to appropriately adjust the pressurized state in the extraction and separation column 30 as described above.

The respective pressures in the first pressurized state and the second pressurized state held by controlling the first back pressure adjustment mechanism 40 and the second back pressure adjustment mechanism 50 by the control unit 60 are not particularly limited as long as the pressure in the second pressurized state is lower than that in the first pressurized state by a predetermined pressure difference and the fluid C in the supercritical state can be maintained in the supercritical fluid state.

On the other hand, in the embodiment, in particular, in a case where the feed solution B contains the slurry-like target substance (separated substance) M in the raw material, from the viewpoint of preventing the separated substance from freezing, it is preferable that the pressure in the second pressurized state is lower by a range of 0.05 MPa to 0.15 MPa than that in the first pressurized state. That is, it is preferable that the control unit 60 controls the first back pressure adjustment mechanism 40 and the second back pressure adjustment mechanism 50 such that the pressure in the second pressurized state in the extraction and separation column 30 is lower by the range of 0.05 MPa to 0.15 MPa than that in the first pressurized state.

As a method for implementing the above-described pressure state, specifically, first, the second back pressure adjustment mechanism 50 is set to an open state (at this time, the first back pressure adjustment mechanism 40 is in a closed state), and a flow rate of the liquid feeding pressure pump 4 and the opening and a valve opening time (first predetermined time) of the second back pressure adjustment mechanism 50 are adjusted such that the dry gas flowmeter 53 has a constant flow rate, thereby extracting a part of the supercritical fluid and reducing the pressure in the second pressurized state (step (i)).

Next, the second back pressure adjustment mechanism 50 is set to a closed state, the first back pressure adjustment mechanism 40 is set to an open state, a flow rate of the wet gas flowmeter 43, a flow rate of the liquid feeding pressure pump 23, the opening and a valve opening time (second predetermined time) of the first back pressure adjustment mechanism 40 are adjusted, and a part of the supercritical fluid is extracted (step (ii)).

The second back pressure adjustment mechanism 50 is set to the open state and the first back pressure adjustment mechanism 40 is set to the closed state again, and the above step (i) and step (ii) are repeated at predetermined intervals to control an extraction amount by adjusting the opening. By such an operation, when a pressure difference in the range of 0.05 MPa to 0.15 MPa occurs between the pressure in the second pressurized state and that in the first pressurized state (hereinafter, also referred to as a “steady state”), the first separation tank 42 is installed to separate and recover the concentrate of the target substance M (step (iii)).

In the invention, the reason why the steady state is set by performing the extraction a plurality of times as described above is to confirm whether the steady state is established while preventing the occurrence of a change in properties of the supercritical fluid due to a rapid pressure change and the occurrence of a failure of the extraction and separation column 30. Whether the steady state is reached is determined by checking whether the detection value of the pressure sensor P and the discharge at the time of extraction are steady (whether there is no disturbed pulsation (interval), or whether the blowout of the extracted material is stable (whether the material is uniformly blown out from the flow path)).

As the control described above, for example, the control may be performed while observing and filming a state of the internal fluid under high pressure in real time through a transparent window provided in the oven 70.

When the adjustment is performed from the flow rates as described above, each flow rate may be determined from a phase diagram of a component system based on a Pegn-Robinson (PR) model for a vapor-liquid equilibrium state.

The control unit 60 controls the first back pressure adjustment mechanism 40 and the second back pressure adjustment mechanism 50 such that the pressures in the first pressurized state and the second pressurized state have a steady state relationship, whereby a pressure difference is generated between the gas phase side (upper end 30b side) and the liquid phase side (lower end 30a side) in the extraction and separation column 30. Accordingly, occurrence of rapid adiabatic expansion on the outlet side of the first back pressure adjustment mechanism 40 is restricted, and thus it is possible to restrict freezing of the slurry-like separated substance. Accordingly, it is possible to prevent the first back pressure adjustment mechanism 40, the pipes upstream of and downstream of the first back pressure adjustment mechanism 40, and the like from being clogged, and thus the productivity of the target substance M is excellent and the maintainability is also excellent.

Further, as described above, by generating a pressure difference between the gas phase side and the liquid phase side in the extraction and separation column 30, a force of extruding the slurry-like separated concentrate from the lower portion of the extraction and separation column 30, that is, the lower end 30a disposed on the liquid phase side, by the pressure difference acts, and the separated concentrate is easily taken out.

In addition, it is preferable that the control unit 60 performs control such that the second back pressure adjustment mechanism 50 is opened to set the pressure in the second pressurized state on the upper portion side of the extraction and separation column 30 to a pressure lower than that in the first pressurized state on the lower portion side by a predetermined pressure difference, and then the second back pressure adjustment mechanism 50 is closed and the first back pressure adjustment mechanism 40 is opened. By controlling opening timings and closing timings of the first back pressure adjustment mechanism 40 and the second back pressure adjustment mechanism 50 as described above, it is possible to prevent the first back pressure adjustment mechanism 40 and the pipes from being clogged due to freezing of the separated substance when collecting the concentrate (separated substance) of the slurry-like target substance M contained in the feed solution B.

It is preferable that the opening timings, the closing timings and the opening of the first back pressure adjustment mechanism 40 and the second back pressure adjustment mechanism 50 in a case where the control as described above is performed are set while being appropriately adjusted such that no reversed flow or the like occurs upstream of and downstream of the back pressure valves constituting the first back pressure adjustment mechanism 40 and the second back pressure adjustment mechanism 50 or in the extraction and separation column 30.

The control unit 60 can continuously perform operation of the supercritical fluid device 100 in the steady state and operation of repeatedly controlling the opening and closing of the first back pressure adjustment mechanism 40 and the second back pressure adjustment mechanism 50 described above. Accordingly, it is possible to obtain the target substance M while maintaining excellent operation efficiency of the supercritical fluid device 100. From the viewpoint of the operation efficiency of the supercritical fluid device 100, it is preferable that a difference between the opening timing and the closing timing for the first back pressure adjustment mechanism 40 and the second back pressure adjustment mechanism 50 is as small as possible. On the other hand, when the difference between the opening timing and the closing timing is too small, there is a possibility that the fluids are simultaneously led out from the liquid phase side and the gas phase side in the extraction and separation column 30. Therefore, it is preferable to appropriately adjust and set the difference between the opening timing and the closing timing to be equal to or greater than a certain value by the control unit 60.

An opening time (and a closing time) of the first back pressure adjustment mechanism 40 and the second back pressure adjustment mechanism 50 is not particularly limited, and it is preferable that the opening time of the first back pressure adjustment mechanism 40 is set by the control unit 60 to be, for example, about 2 seconds to 3 seconds in consideration of the opening timing and the closing timing.

The control unit 60 is not particularly limited, and for example, a dedicated circuit including a control circuit including a CPU or the like can be used. Alternatively, for example, by connecting a general personal computer (PC) or tablet terminal to the supercritical fluid device 100, the PC or tablet terminal can be used as the control unit 60.

In the supercritical fluid device 100 according to the embodiment, although not illustrated in FIG. 1, when a modifier (for example, an ethanol solution or an aqueous ethanol solution) is contained in the concentrated extract (target substance M), an evaporator or the like for separating the target substance M and the ethanol solution (aqueous ethanol solution) may be further provided.

In addition, as described above, in a case of recovering and reusing the fluid (for example, carbon dioxide gas) separated in the first separation tank 42 or the second separation tank 52, for example, a configuration including a circulation mechanism (not illustrated) for re-liquefying the fluid, refluxing the fluid to the supercritical fluid source storage tank 1, and recirculating the fluid may be adopted.

The separation target of the supercritical fluid device 100 according to the embodiment is not particularly limited, and extraction and separation of a separation target containing various substances is possible. In particular, when performing separation processing for a separation target containing a target substance in a sample containing a slurry-like solid matter is performed as described above, the excellent effects described above can be exhibited.

### <Solvent Extraction and Separation Method>

Hereinafter, the solvent extraction and separation method according to the embodiment will be described with reference to the configuration of the supercritical fluid device 100 according to the embodiment illustrated in FIG. 1 as appropriate. A detailed description the configuration of the supercritical fluid device 100 described above will be omitted.

The solvent extraction and separation method according to the embodiment is a method of separating and recovering the concentrated target substance M from the feed solution B by bringing the fluid C in a supercritical state, which is a mobile phase to be a supercritical fluid, into counterflow contact with the feed solution B containing the separation target in the extraction and separation column 30 using the supercritical fluid device 100 according to the embodiment, and extracting and separating the solvent from the feed solution B.

According to the solvent extraction and separation method according to the embodiment, by separating and recovering the concentrated target substance M from the feed solution B using the supercritical fluid device 100 according to the embodiment, it is possible to prevent the slurry-like separated substance from freezing and clogging on the outlet side of the first back pressure adjustment mechanism 40 connected to the lower end 30a of the extraction and separation column 30 as described above. Further, by using the supercritical fluid device 100, the concentrate of the target substance M can be easily taken out from the lower end 30a that is the liquid phase side of the extraction and separation column 30. Therefore, the concentrate of the target substance M can be continuously separated and recovered from the feed solution B with high productivity.

### <Method for Producing Product>

Similarly to the solvent extraction and separation method according to the embodiment described above, the method for producing a product according to the embodiment is a method of concentrating and separating the target substance M from the separation target (for example, the feed solution B containing the raw material and the modifier) using the supercritical fluid device 100 according to the embodiment illustrated in FIG. 1, and producing a product containing the concentrated and separated target substance M as a functional component.

A specific process of the method for producing a product according to the embodiment is similar to that of the solvent extraction and separation method according to the embodiment described above, and a detailed description thereof will be omitted.

<Target Substance Extracted and Separated from Separation Target>

The target substance that can be obtained by the supercritical fluid device according to the embodiment as described above and the solvent extraction and separation method using the supercritical fluid device is not particularly limited, and examples thereof include various foods, drugs, and supplements.

As described above, with the supercritical fluid device and the solvent extraction and separation method according to the embodiment, it is possible to restrict freezing of the separated substance (target substance) from the slurry-like sample, it is possible to prevent clogging from occurring inside, and it is easy to take out the concentrate of the target substance M. Therefore, the productivity of the target substance obtained by the supercritical fluid device and the solvent extraction and separation method according to the embodiment, that is, foods, drugs, supplements, and the like is excellent, and the quality is also excellent since there is no organic solvent or unnecessary pretreatment.

The supercritical fluid device and the solvent extraction and separation method according to the embodiment are useful not only in the productivity and quality from the industrial production viewpoint as described above, but also in the development of various applications such as the production of drugs friendly to humans and the global environment, and the separation of color, aroma, and taste in the production of foods, beverages, and the like.

### <Functions and Effects>

As described above, according to the supercritical fluid device according to the embodiment, as described above, the control unit 60 controls the first back pressure adjustment mechanism 40 and the second back pressure adjustment mechanism 50 such that the pressure in the second pressurized state on the upper portion side in the extraction and separation column 30 is reduced by a predetermined pressure difference with respect to the pressure in the first pressurized state on the lower portion side. Accordingly, since a pressure difference occurs between the gas phase side and the liquid phase side in the extraction and separation column 30, it is possible to restrict the occurrence of rapid adiabatic expansion on the outlet side of the first back pressure adjustment mechanism 40 and to prevent the occurrence of clogging due to freezing of the slurry-like separated substance. In addition, since a pressure difference occurs between the gas phase side and the liquid phase side, it is easy to take out the separated substance from the lower end 30a that is the liquid phase side of the extraction and separation column 30. Therefore, the supercritical fluid device 100 having excellent productivity and maintainability can be provided.

Further, according to the solvent extraction and separation method according to the embodiment, a method of separating and recovering the target substance M from the feed solution B containing the separation target using the supercritical fluid device 100 having the above configuration is adopted. Accordingly, similarly to the above, it is possible to prevent the slurry-like separated substance from freezing and causing clogging on the outlet side of the first back pressure adjustment mechanism 40, and it is easy to take out the slurry-like separated substance from the liquid phase side. Therefore, the target substance M can be continuously separated and recovered from the feed solution B containing the raw material with high productivity.

### <Other Embodiments of Invention>

Although a preferred embodiment of the invention has been described in detail above, the invention is not limited to the specific embodiment described above, and various modifications and changes are possible within the scope of the gist of the invention described in the claims.

### INDUSTRIAL APPLICABILITY

The supercritical fluid device of the invention is excellent in productivity and maintainability without clogging a back pressure valve, a pipe, or the like even when taking out a slurry-like separated substance from the liquid phase side. Since a slurry-like separated substance can be handled, the labor and time of pretreatment when extracting a target substance from a naturally derived component are reduced. Since the target substance is less likely to be denatured and no harmful organic solvent is contained, a product excellent in productivity and safety can be applied. Therefore, the supercritical fluid device of the invention is very suitable for a producing process of a product containing a target substance as a functional component, such as a drug, a cosmetic, a supplement, or a food material, using the target substance obtained by using the supercritical fluid device of the invention, for example.

### REFERENCE SIGNS LIST

100: supercritical and subcritical fluid device (supercritical fluid device)
10: first liquid feeding part
11: first flow path
1: supercritical fluid source storage tank
2: pressure reducing valve
3: filter
4: liquid feeding pressure pump
5: cooler
6: safety valve
7: flow rate control valve
8: vent valve
20: second liquid feeding part
21: second flow path
22: separation target solution storage tank
22a: opening
23: liquid feeding pressure pump
24: flow rate control valve
30: extraction and separation column
30a: lower end (lower portion side)
30b: (upper portion side)
31: lower introduction port
32: upper introduction port
40: first back pressure adjustment mechanism
41: third flow path
42: first separation tank
42a: front-stage tank
42b: rear-stage tank
43: wet gas flowmeter
50: second back pressure adjustment mechanism
51: fourth flow path
52: second separation tank
52a: front-stage tank
52b: rear-stage tank
53: dry gas flowmeter
54: outlet valve
60: control unit
70: oven
70A: first oven
70B: second oven
71, 72: pre-ribbon heater
P: pressure sensor
C: fluid in supercritical state (mobile phase to be supercritical fluid)
B: feed solution (separation target) containing raw material and modifier
M: target substance (slurry-like target substance; separated substance)
G: fluid (carbon dioxide gas)

1. A supercritical and subcritical fluid device comprising:
a extraction and separation column;
a first liquid feeding part connected to a lower portion of the extraction and separation column via a first flow path and configured to supply a mobile phase serving as a supercritical fluid;
a second liquid feeding part connected to an upper portion of the extraction and separation column via a second flow path and configured to supply a separation target;
a first back pressure adjustment mechanism connected to the lower portion of the extraction and separation column via a third flow path and configured to set an inside of the extraction and separation column to a first pressurized state in which the mobile phase is maintained in a supercritical fluid state;
a second back pressure adjustment mechanism connected to the upper portion of the extraction and separation column via a fourth flow path and configured to set the inside of the extraction and separation column to a second pressurized state in which the mobile phase is maintained in a supercritical fluid state; and
a control unit configured to control the first back pressure adjustment mechanism and the second back pressure adjustment mechanism, wherein
the control unit controls the first back pressure adjustment mechanism and the second back pressure adjustment mechanism such that the second pressurized state is reduced by a predetermined pressure difference with respect to the first pressurized state.

2. The supercritical and subcritical fluid device according to claim 1, wherein
in the third flow path, a cross-sectional area of a flow path downstream of the first back pressure adjustment mechanism is larger than a cross-sectional area of a flow path connected to the first back pressure adjustment mechanism on a extraction and separation column side.

3. The supercritical and subcritical fluid device according to claim 1, wherein
the control unit controls the first back pressure adjustment mechanism and the second back pressure adjustment mechanism such that the pressure in the second pressurized state is lower by a range of 0.05 MPa to 0.15 MPa than the pressure in the first pressurized state.

4. The supercritical and subcritical fluid device according to claim 1, wherein
the control unit
(i) opens the second back pressure adjustment mechanism for a first predetermined time in a state in which the first back pressure adjustment mechanism is closed, and extracts a first predetermined amount to reduce the pressure in the second pressurized state with respect to the pressure in the first pressurized state,
(ii) opens the first back pressure adjustment mechanism for a second predetermined time in a state in which the second back pressure adjustment mechanism is closed, and extracts a second predetermined amount, and
(iii) repeats the operations (i) and (ii) to control the second pressurized state to have a pressure lower by the predetermined pressure difference with respect to the first pressurized state.

5. The supercritical and subcritical fluid device according to claim 1, wherein
the separation target contains a slurry-like target substance.

6. The supercritical and subcritical fluid device according to claim 5, wherein
the control unit further performs control to collect an extract containing the slurry-like target substance contained in the separation target by closing the second back pressure adjustment mechanism and opening the first back pressure adjustment mechanism.

7. A solvent extraction and separation method comprising:
separating and recovering a target substance from a separation target by bringing a mobile phase serving as a supercritical fluid into counterflow contact with the separation target in the extraction and separation column and extracting and separating a solvent from the separation target using the supercritical and subcritical fluid device according to claim 1.

8. A method for producing a product, the method comprising:
concentrating and separating a target substance from a separation target using the supercritical and subcritical fluid device according to claim 1, and producing a product containing the concentrated and separated target substance as a functional component.
